(19) United States
(12) Patent Application Publication
(10) Pub. No.: US 2022/0092320 A1
(43) Pub. Date: Mar. 24, 2022

(54) Method and System for Generating Ground-Truth Annotations of Roadside Objects in Video Data

(71) Applicant: NavInfo Europe B.V., Eindhoven (NL)

(72) Inventors: Terence Brouns, Eindhoven (NL); Elahe Arani, Eindhoven (NL); Bahram Zonooz, Eindhoven (NL)

(21) Appl. No.: 17/482,339

(22) Filed: Sep. 22, 2021

(30) Foreign Application Priority Data
Sep. 23, 2020 (NL) 2026528

(51) Int. Cl. G06K 9/00; G06K 9/62; G06T 7/20

(52) U.S. Cl. CPC G06K 9/00818; G06K 9/6218; G06T 7/20; G06T 2207/30241; G06T 2207/10016; G06T 2207/30252; G06K 9/6267

(57) ABSTRACT

A method and system for generating ground-truth annotations for object detection and classification for roadside objects in video data, wherein the method uses in combination an object detector to detect object instances of roadside objects in each frame of a video, a visual object tracker to detect and track the roadside object across the remaining video frames the roadside object appears in and clusters these detected object instances of the same roadside object into an object track, a trajectory analyzer to filter out object tracks that are unlikely from roadside objects, a classification model to classify each object instance in the object track into a predefined roadside object class, after which the object track as a whole is classified by seeking consensus among the individual object instance classifications in the object track, and classification consistency to determine whether the resulting roadside object class can be assigned automatically to the concerning object track as a ground-truth annotation or whether the ground-truth annotation should be manually verified by an operator. Accordingly, it is possible with the invention to convert model prediction labels in an automated way into ground-truth annotations, so as to create ground-truth annotations with a similar reliability as manual annotation and significantly reduce the amount of manual effort involved in creating reliable ground-truth annotations.

### CROSS-REFERENCE TO RELATED APPLICATIONS

This application claims priority to and the benefit of Netherland Patent Application No. 2026528, titled “METHOD AND SYSTEM FOR GENERATING GROUND-TRUTH ANNOTATIONS OF ROADSIDE OBJECTS IN VIDEO DATA”, filed on Sep. 23, 2020, and the specification and claims thereof are incorporated herein by reference.

### BACKGROUND OF THE INVENTION

### Field of the Invention

Embodiments of the present invention relate to a method of generating ground-truth annotations for object detection and classification for roadside objects in video data. The invention is also embodied in a system for generating ground-truth annotations for roadside objects in video data.

Detection and recognition of static roadside objects (e.g., traffic signs) in video data collected by vehicle-mounted cameras is a crucial aspect of high-definition (HD) mapping and autonomous driving. State-of-the-art approaches in this field use artificial intelligence (AI) models based on neural network architectures, which need to be trained and tested on large image datasets that contain ground-truth annotations. These ground-truth annotations are typically created by human annotators by using an annotation tool to manually provide labels to images, which is highly resource consuming.

### Background Art

There have been earlier attempts to avoid this high level of human intervention by using heavy state-of-the-art object detection and classification models trained on a pre-existing annotated dataset to predict labels for a new unannotated dataset, where each model prediction label is directly used as a ground-truth annotation if the corresponding model confidence score surpasses a predefined threshold value. The ground-truth annotations are then used to train a different and typically lighter object detection or classification model on the new dataset, a process referred to as pseudo-labelling. Reference is made to Lee, D. H. (2013, June). Pseudo-label: The simple and efficient semi-supervised learning method for deep neural networks. In Workshop on challenges in representation learning, ICML (Vol. 3, No. 2, p. 896).

The problem with the pseudo-labelling approach is that each sample in the dataset is treated individually and therefore the reliability of the predicted labels is fully dependent on the performance of the aforementioned heavy models, which means that the lighter models trained on such a dataset can only reach a lower or at best same level of performance as the heavy models. Additionally, the dataset used to train the heavy models is likely significantly different than the new unannotated dataset, because the datasets that are most desirable to annotate are typically datasets that are significantly different from any pre-existing annotated dataset. Therefore, the heavy models are likely to have mediocre performance as a result of this data distribution shift. Furthermore, the model confidence score alone is frequently a poor indicator whether a model prediction label is reliable or not, especially in the case of data distribution shift.

Lafuente-Arroyo, S., Maldonado-Bascon, S., Gil-Jimenez, P., Gomez-Moreno, H., & Lopez-Ferreras, F. (2006, November). Road sign tracking with a predictive filter solution. In IECON 2006-32nd Annual Conference on IEEE Industrial Electronics (pp. 3314-3319). IEEE disclosed an earlier attempt to improve the performance of object detection and classification of traffic signs by exploiting temporal coherence in video data using an object tracker, where the object tracker uses a rule-based association algorithm to connect detected object instances of the same traffic sign across the video frames together into object tracks. In each video frame, the association algorithm compares each detected object instance with previously detected object instances in existing object tracks to determine whether the object instance can be associated with an existing object track or whether a new object track should be created. Afterwards, a traffic sign is classified using majority voting by calculating the most frequently occurring classification result across the individual object instance classifications in the corresponding object track and assigning the resulting object class to the associated traffic sign.

Note that this application refers to a number of publications. Discussion of such publications herein is given for more complete background and is not to be construed as an admission that such publications are prior art for patentability determination purposes.

### BRIEF SUMMARY OF THE INVENTION

A limitation of a rule-based association algorithm is that it generalizes poorly across a wide range of roadside objects and can typically not differentiate between distinct object classes within a particular subcategory (e.g., warning signs) unlike modern state-of-the-art visual object trackers based on deep neural network architectures. Furthermore, an association algorithm cannot recover any object instances that the object detector has failed to detect, thus making the method fully dependent on the performance of the object detector and therefore vulnerable to the adverse effects of data distribution shift. The method further only filters out erroneous detections from the object detector by not associating these erroneous detections with an existing object track on a frame-to-frame basis, but this filtering step fails in the more likely scenario where erroneous detections get associated with an object track due to partial temporal coherence. Additionally, majority voting implements a winner-takes-all rule that ignores informative class probability output from the classification model, which makes majority voting typically less reliable compared with classification schemes that make use of the class probabilities. Also, majority voting provides no measure of the reliability of a predicted object class that is calculated by the majority vote procedure, which makes majority voting unsuitable for automatic ground-truth annotation, because it cannot be used to differentiate between confident and non-confident predictions.

It is an object of the invention to automate a large part of the process of generating ground-truth annotations for object detection and classification of roadside objects in video data while maintaining a similar level of ground-truth annotation reliability compared to manual annotation and leaving only the difficult samples for the human annotator to annotate in an accelerated manner.

According to an embodiment of the present invention a method and system is proposed with the features of one or more of the appended claims.

In a first aspect, the system and the method according to the invention use in combination an object detector to detect object instances of roadside objects in each frame of a video, a visual object tracker to detect and track the roadside object across the remaining video frames the roadside object appears in and clusters these detected object instances of the same roadside object into an object track, a trajectory analyzer to filter out object tracks that are unlikely from roadside objects, a classification model to classify each object instance in the object track into a predefined roadside object class, after which the object track as a whole is classified by seeking consensus among the individual object instance classifications in the object track, and classification consistency to determine whether the resulting roadside object class can be assigned automatically to the concerning object track as a ground-truth annotation or whether the ground-truth annotation should be manually verified by an operator. Accordingly, it is possible with the invention to convert model prediction labels in an automated way into ground-truth annotations, so as to create ground-truth annotations with a similar reliability as manual annotation and significantly reduce the amount of manual effort involved in creating said ground-truth annotations.

In a further aspect of the invention, it is beneficial that the visual object tracker is used to detect and track roadside objects, so as to complement the object detector by increasing the fraction of relevant object instances that are retrieved from the video. A visual object tracker is used for this purpose, because its performance is only marginally impacted by the adverse effects of data distribution shift and can reliably generalize across a wide range of roadside object classes.

It is preferable that the visual object tracker is initialized with a most confident detection from the object detector of each roadside object and then detects and tracks the roadside object both forward and backward in time across the frames of the video, so as to promote the reliability of the visual object tracker.

It is further advantageous that the visual object tracker is used to cluster detected object instances of the same roadside object into an object track, so as to allow for trajectory analysis and classification by consensus.

Trajectories of centroid position and bounding box size of the object instances in the object track are analyzed to determine whether the track is realistic for a roadside object, after which any improbable object tracks are filtered out. By analyzing the object track as a whole, it is possible to filter out erroneous detections from the object detector even when they have partial temporal coherence.

The trajectory of centroid position of the object instances in an object track is suitably marked as realistic if it starts approximately in a vanishing point of the road and then moves radially outwards until the object track ends.

Preferably the trajectory of bounding box size of the object instances in an object track is marked as realistic if it approximately has a smallest size at the start of the object track and then monotonically increases until the object track ends.

Further, a classification score is advantageously calculated for each roadside object class by averaging class probabilities from the classification model for the corresponding roadside object class across the object instances in the object track, where the classification score provides a measure of classification consistency. The classification score is consequently used as a more informative measure for the reliability of a model prediction label as compared with individual model confidence scores.

Desirably the roadside object class with a highest classification score is automatically assigned as the ground-truth annotation for the corresponding object track if the classification score surpasses a predefined threshold value and if the classification score remains below said predefined threshold value leaves the assignment of a ground-truth annotation to the operator.

To promote the reliability of automated annotation, object instances in the same object track are classified by consensus when the assignment of the ground-truth annotation is provided automatically, where the roadside object class with the highest classification score is assigned to all the individual object instances in the object track as a ground-truth annotation.

To promote manual annotation speed, all object instances in the same object track are jointly annotated in one single action when the assignment of the ground-truth annotation is provided by an operator, which is achieved by displaying all of them at once in an annotation tool and requiring only the roadside object class name as input from the operator. This speeds up manual annotation by a factor equal to the number of object instances in the object track and further eliminates the need to annotate the position of the roadside object, which is typically the most time-consuming part of manual annotation.

In a final aspect of the invention, the classification model is re-trained every time a predefined number of roadside objects have been provided with ground-truth annotations, where said ground-truth annotations are used during model training, so as to promote the reliability of the method.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 shows a flowchart of a pipeline to generate ground-truth annotations in a semi-automated fashion according to an embodiment of the present invention;

FIG. 2 shows an illustration of a highest classification score calculation for a particular object track according to an embodiment of the present invention; and

FIG. 3 shows an example display of graphical user interface of an annotation tool according to an embodiment of the present invention.

### DETAILED DESCRIPTION OF THE INVENTION

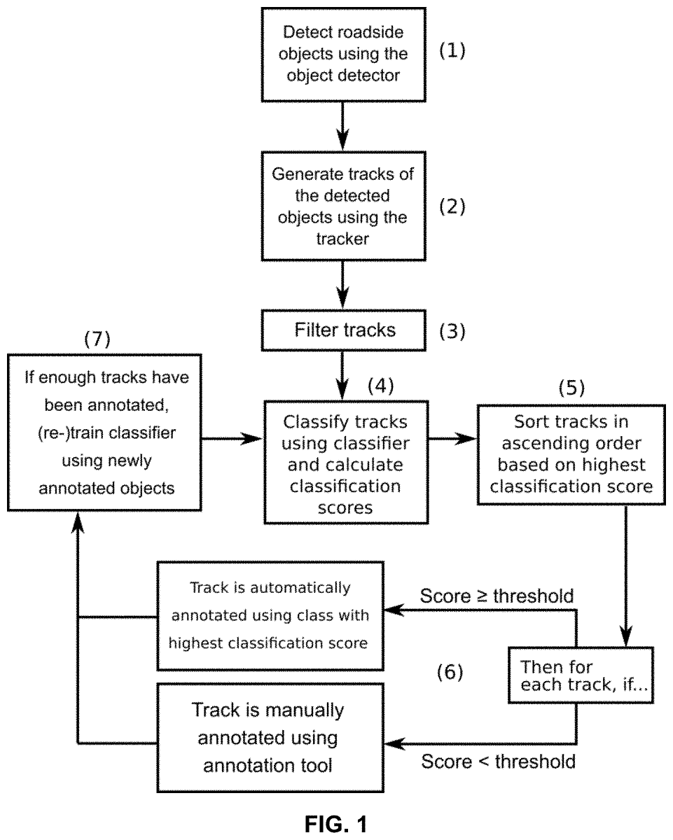

With reference to FIG. 1 the following steps of the method of an embodiment of the present invention can be identified.

### Step 1)

In Step 1, an object detector (e.g., Duan et al., 2019) is used to detect instances of roadside objects in each frame of a video. The object detector takes an image as input and then outputs the positions of roadside objects in the image as bounding boxes, together with a confidence level for each bounding box prediction. The object detector is pre-trained on a pre-existing street-level dataset that is generic in nature and contains ground-truth annotations for roadside objects, such as Mapillary Vistas. It is only necessary for the pre-existing dataset to have bounding box annotations for the roadside objects of interest, and not necessary to have specific roadside object class annotations.

### Step 2)

In Step 2, a visual object tracker (e.g., Bhat et al., 2019) is used to detect and track the roadside objects detected by the object detector across the remaining video frames the object appears in. The visual object tracker takes as input a cropped region of the image corresponding to the location of an object instance in one frame of the video and then outputs the locations of all other object instances associated with the same object in the other frames of the video.

An object tracker is used to complement the object detector, because the object detector is unlikely to detect every roadside object of interest in every frame of the video, especially if the video data is significantly different compared to the pre-existing dataset the object detector was pre-trained on (data distribution shift). The object tracker can recover the object instances that the object detector failed to detect and thus increase the fraction of relevant object instances that are retrieved from the video.

The object detector is still likely, however, to detect multiple object instances of the same roadside object, but only one of these object instances should be used as input to the object tracker. This is achieved by taking each detection from the object detector in turn as input to the object tracker, starting with the most confident detection down to the least confident detection. A detected object instance is not used to initialize an object track if it overlaps with an object instance from an existing object track or if the detection confidence is below a pre-defined threshold (default=0.3). This ensures that for each object track, the object tracker is initialized using the most confident detection for that object, which helps to promote the reliability of the object tracker.

Furthermore, since the most confident detection is probably not in the first or the last video frame the roadside object appears in, the object is tracked both forwards and backwards in time in order to retrieve all object instances of the roadside object in the video.

### Step 3)

In Step 3, trajectories of the centroid position and bounding box size of the object instances in the object track are analyzed to determine whether the object track is realistic for a roadside object, after which any improbable object tracks are filtered out.

The object detector is likely to erroneously detect a significant number of objects that are not roadside objects, especially in the case of a data distribution shift as mentioned before. Furthermore, the visual object tracker will track any object that it gets as input, irrespective of it being a roadside object or not. Hence, a significant number of object tracks of non-roadside objects will be generated that need to be filtered out.

The steps of filtering using trajectory analysis are further elucidated in the Steps 3.1-3.3.

### Step 3.1)

In Step 3.1, any overlapping object tracks are filtered out. The amount of overlap is calculated by determining a bounding box intersection over union (IoU) in video frames in which both object tracks exist. If the average IoU across these video frames is higher than a predefined threshold (default=0.25), then only the object track with the highest classification score (see Step 4) is kept.

### Step 3.2)

In Step 3.2, it is evaluated whether the trajectory of the bounding box centroid in each object track is realistic. It is expected that the bounding box centroid starts approximately in the vanishing point of the road and then moves radially outwards until the object track ends. Accordingly, the filtering algorithm works in the following way:

For each object track in the video, the method carries out the following algorithm:
1. Get the trajectory of the bounding box centroid of the object instances in the object track.
2. Smooth the trajectory using a moving average with a predefined window size (default=10) to deal with jitter.
3. Then for all object instances in the object track, do the following:
   a. Calculate vector difference between the centroid of the object instance in the current video frame and the centroid of the object instance in the next video frame (v_{actual,t}) for each video frame in the object track, in chronological order:

v_{actual,t}=(xₜ₊₁−xₜ,yₜ₊₁−yₜ)
Where:
xₜ: x position in image coordinates (pixels) of object instance in video frame t
yₜ: y position in image coordinates (pixels) of object instance in video frame t
b. Calculate vector difference between the centroid of the vanishing point position of the road and the centroid of the object instance in the current frame (v_{expected,t}) for each video frame in the object track, in chronological order:

v_{expected,t}=(vₓ−xₜ,v_{y}−yₜ)
Where:
vₓ: x position in image coordinates of the vanishing point of the road
v_{y}: y position in image coordinates of the vanishing point of the road
The vanishing point position is calculated using a suitable algorithm, which is done once for the whole video.
c. Normalize both vector differences, v_{actual} and v_{expected}:

$$\hat{υ} = \frac{υ}{\vert υ \vert}$$

d. Calculate magnitude of difference (dr) between \hat{v}_{actual,t} and \hat{v}_{expected,t}, and weigh this with the magnitude of v_{actual,t}:

dₜ=∥v_{actual,t}∥*∥\hat{v}_{actual,t}−\hat{v}_{expected,t}∥
4. Afterwards, the average magnitude d̅ is calculated as follows:

$$\overline{d} = \frac{{\sum }^{T} {d}_{t}}{{\sum }^{T} ‖ {υ}_{actual , t} ‖}$$

Where:
T: number of video frames in the object track
5. If d̅ is larger than a predefined threshold (default=0.75), then the object track is filtered out.

### Step 3.3)

In Step 3.3, it is evaluated if the trajectory of the bounding box size is realistic. It is expected that the bounding box approximately has the smallest size at the start of the object track and then monotonically increases until the object track ends. Accordingly, the filtering algorithm works in the following way:

For each object track in the video, the method carries out the following algorithm:
1. Get the trajectory of the bounding box (w) and (h) of the object instances in the object track.
2. Smooth the trajectory using a moving average with a predefined window size (default=10) to deal with jitter.
3. Perform linear regression on the width and height data points, and determine the direction of the fitted model as a unit vector representation, \hat{v}_{fit}.
4. Then for all object instances in the object track, do the following:
   a. Calculate vector difference between the bounding box size of the object instance in the current video frame and the bounding box size of the object instance in the next video frame (v_{actual,t}) for each video frame in the object track, in chronological order:

v_{actual,t}=(wₜ₊₁−wₜ,hₜ₊₁−hₜ)
Where:
wₜ: width of bounding box of object instance in video frame t
hₜ: height of bounding box of object instance in video frame t
b. Normalize the vector difference, v_{actual,t}:

$$\hat{υ} = \frac{υ}{\vert υ \vert}$$

c. Calculate the angle θₜ between \hat{v}_{fit} and \hat{v}_{actual,t} and weigh this with the magnitude of v_{actual,t}:

θₜ=∥v_{actual,t}∥*|arccos(\hat{v}_{fit}·\hat{v}_{actual})|
5. Afterwards, the average angle θ̅ₜ is calculated as follows:

$${\overline{θ}}_{t} = \frac{{\sum }^{T} {θ}_{t}}{{\sum }^{T} ‖ {υ}_{actual , t} ‖}$$

Where:
T: number of video frames in the object track
6. If θ̅ₜ is larger than a predefined threshold

$$( default = \frac{π}{4} ) ,$$

then the object track is filtered out.

### Step 4)

In Step 4, a classification model (e.g., He et al., 2016) is used to classify each object instance in the object track into a predefined roadside object class, after which the method seeks consensus among all the classifications in the object track to classify the object track as a whole.

It is considered that the classification should be consistent across the object instances of the object track if the object track is indeed of the same roadside object. Hence, object instances in the same object track are classified by consensus where the most probable roadside object class for the corresponding roadside object is calculated from the individual classifications of the object instances and then assigning this resulting class to all the individual object instances in the object track. This significantly improves reliability of classification, because the result is based on multiple data points, rather than just a single data point as in the traditional approach of only classifying each object instance individually.

The most probable roadside object class for the object track is determined by a classification score that is calculated for each roadside object class by averaging the class probabilities from the classification model for the corresponding class across the object instances in a single object track. The roadside object class with the highest classification score is then assigned to the object track in question.

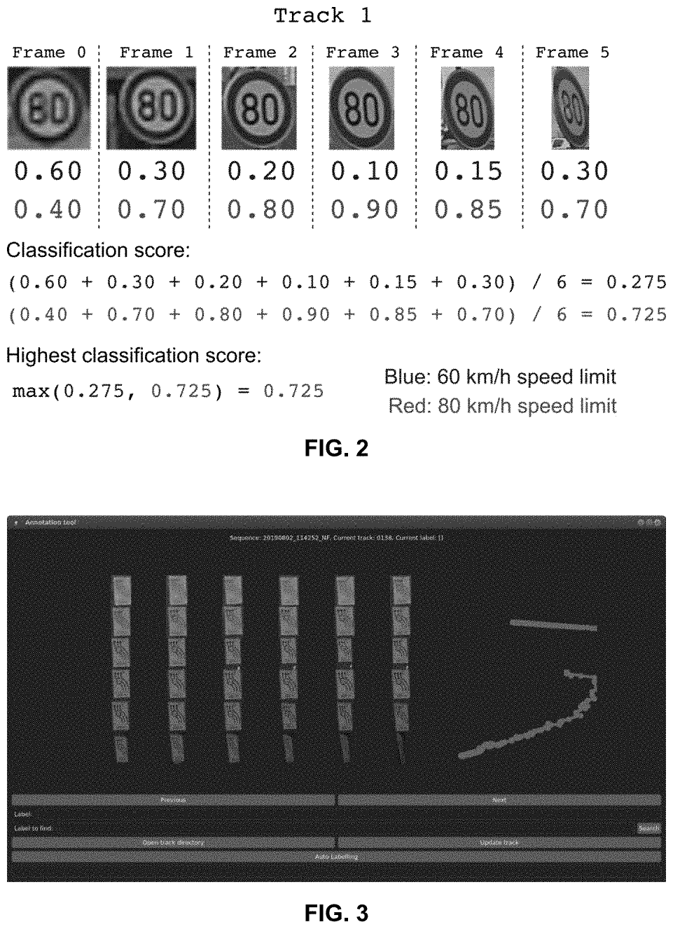

FIG. 2 shows as an example a “80 km/h speed limit” traffic sign that has been tracked across six video frames. For the object instance in the first frame (“Frame 0”), the classification model assigned probabilities of 0.60 and 0.40 to the roadside object classes “60 km/h speed limit” and “80 km/h speed limit” respectively (other classes are omitted for clarity). For the object instance in the next frame (“Frame 1”), it respectively assigned 0.30 and 0.70, and so on for the remaining object instances. The classification score is calculated by averaging the probabilities for each roadside object class across the object instances in the object track, resulting in 0.275 and 0.725 for the two classes respectively. Since 0.725 is the highest score, the corresponding “80 km/h speed limit” roadside object class is assigned to this particular object track.

It is noted that it is not necessary to have a pre-trained classification model at the beginning of this process. The method of the invention can start off by setting all classification scores to zero.

### Step 5)

In Step 5, all the created object tracks are sorted according to their highest classification score in ascending order. This ensures that annotation of the most difficult object tracks starts first.

### Step 6)

In Step 6, for each object track, the method checks if the highest classification score for that object track surpasses a predefined threshold (default=0.90). If it does, then the object track is automatically assigned the corresponding roadside object class as a ground-truth annotation. Otherwise, the assignment of a ground-truth annotation is left to the operator, where all object instances in the same object track are jointly annotated in one single action by displaying all of them at once in an annotation tool (see FIG. 3) and requiring only the roadside object class name as input from the operator. This avoids the need to annotate the bounding box and class name of each object instance individually as in the traditional approach, thus resulting in a dramatic speed-up in the manual annotation process.

### Step 7)

In Step 7, after a predefined number of roadside objects have been provided with ground-truth annotations, the new ground-truth annotations are added to the training set to re-train the classification model, after which the cycle continues with Step 4 until sufficient ground-truth annotations are generated. By re-training the classification model on these new ground-truth annotations, the effect of data distribution shift for classification is mitigated and thus the reliability of the method is improved. It is also possible to use the new ground-truth annotations to re-train the object detector and restart the process from Step 1.

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the appended claims strictly in accordance therewith. On the contrary, the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited herein are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

### REFERENCES

Bhat, G., Danelljan, M., Gool, L. V., & Timofte, R. (2019). Learning discriminative model prediction for tracking. In Proceedings of the IEEE/CVF International Conference on Computer Vision (pp. 6182-6191).
Duan, K., Bai, S., Xie, L., Qi, H., Huang, Q., & Tian, Q. (2019). Centernet: Keypoint triplets for object detection. In Proceedings of the IEEE/CVF International Conference on Computer Vision (pp. 6569-6578).
He, K., Zhang, X., Ren, S., & Sun, J. (2016). Deep residual learning for image recognition. In Proceedings of the IEEE conference on computer vision and pattern recognition (pp. 770-778).
Lafuente-Arroyo, S., Maldonado-Bascon, S., Gil-Jimenez, P., Gomez-Moreno, H., & Lopez-Ferreras, F. (2006, November). Road sign tracking with a predictive filter solution. In IECON 2006-32nd Annual Conference on IEEE Industrial Electronics (pp. 3314-3319). IEEE.
Lee, D. H. (2013, June). Pseudo-label: The simple and efficient semi-supervised learning method for deep neural networks. In Workshop on challenges in representation learning, ICML (Vol. 3, No. 2, p. 896).

1. A method of generating ground-truth annotations for object detection and classification for roadside objects in video data, the method comprising:
detecting object instances of roadside objects in each frame of a video using an object detector;
detecting and tracking the roadside object across the remaining video frames the roadside object appears in and clustering these detected object instances of the same roadside object into an object track, using a visual object tracker;
filtering out object tracks that are unlikely from roadside objects, using a trajectory analyzer; and
classifying each object instance in the object track into a predefined roadside object class, after which the object track as a whole is classified by seeking consensus among the individual object instance classifications in the object track, and classification consistency to determine whether the resulting roadside object class can be assigned automatically to the concerning object track as a ground-truth annotation or whether the ground-truth annotation should be manually verified by an operator, using a classification model.

2. The method of claim 1, further comprising: using the visual object tracker to detect and track roadside objects, so as to complement the object detector by increasing the fraction of relevant object instances that are retrieved from the video.

3. The method of claim 1, further comprising: initializing the visual object tracker with a most confident detection from the object detector of each roadside object and then detecting and tracking the roadside object both forward and backward in time across the frames of the video, so as to promote the reliability of the visual object tracker.

4. The method of claim 1, further comprising: using the visual object tracker to cluster detected object instances of the same roadside object into an object track, so as to allow for trajectory analysis and classification by consensus.

5. The method of claim 1, further comprising: analyzing trajectories of centroid position and bounding box size of the object instances in the object track to determine whether the track is realistic for a roadside object, after which any improbable object tracks are filtered out.

6. The method of claim 5, further comprising: marking the trajectory of centroid position of the object instances in an object track as realistic if it starts approximately in a vanishing point of the road and then moves radially outwards until the object track ends.

7. The method of claim 5, further comprising: marking the trajectory of bounding box size of the object instances in an object track as realistic if it approximately has a smallest size at the start of the object track and then monotonically increases until the object track ends.

8. The method of claim 1, further comprising: calculating a classification score for each roadside object class by averaging class probabilities from the classification model for the corresponding roadside object class across the object instances in the object track, where the classification score provides a measure of classification consistency.

9. The method of claim 8, further comprising: automatically assigning the roadside object class with a highest classification score as the ground-truth annotation for the corresponding object track if the classification score surpasses a predefined threshold value and if the classification score remains below said predefined threshold value leaves the assignment of a ground-truth annotation to the operator.

10. The method of claim 8, further comprising: classifying object instances in the same object track by consensus when the assignment of the ground-truth annotation is provided automatically, where the roadside object class with the highest classification score is assigned to all the individual object instances in the object track as a ground-truth annotation, so as to promote the reliability of automated annotation.

11. The method of claim 8, further comprising: jointly annotating, in one single action, all object instances in the same object track when the assignment of the ground-truth annotation is provided by an operator, which is achieved by displaying all of them at once in an annotation tool and requiring only the roadside object class name as input from the operator, so as to promote manual annotation speed.

12. The method of claim 1, further comprising: re-training the classification model every time a predefined number of roadside objects have been provided with ground-truth annotations, where the ground-truth annotations are used during model training, so as to promote the reliability of the method.

13. A system for generating ground-truth annotations for object detection and classification for roadside objects in video data, the system comprising in combination:
an object detector to detect instances of roadside objects in each frame of a video;
a visual object tracker to detect and track the roadside object across the remaining video frames the roadside object appears in and clusters these detected object instances of the same roadside object into an object track;
a trajectory analyzer to filter out object tracks that are unlikely from roadside objects; and
a classification model to classify each object instance in the object track into a predefined roadside object class, after which the object track as a whole is classified by seeking consensus among the individual object instance classifications in the object track, and classification consistency to determine whether the resulting roadside object class can be assigned automatically to the concerning object track as a ground-truth annotation.
